(19) United States
(12) Patent Application Publication
(10) Pub. No.: US 2003/0204838 A1
(43) Pub. Date: Oct. 30, 2003

(54) Debugging platform-independent software applications and related code components

(76) Inventors: Eric Caspole, Menlo Park, CA (US); Joseph Coha, San Jose, CA (US); Ashish Karkare, San Jose, CA (US); Yanhua Li, Sunnyvale, CA (US); Venkatesh Radhakrishnan, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/136,701

(22) Filed: Apr. 30, 2002

(51) Int. Cl. G06F 9/44

(52) U.S. Cl. 717/130

(57) ABSTRACT

A system and method for debugging a software application written in a platform-independent programming language, including non-application-code components invoked by the software application. The debugging tool and method can generate debugging metrics (e.g. debugging information and analysis) relating to both the software application and the non-application-code component invoked by the software application.

### BACKGROUND OF THE INVENTION

1. Technical Field

The present invention relates in general to the debugging of software applications. More specifically, the present invention relates to a system and method for debugging a software application and a non-application-code component invoked by the executing software application.

### BACKGROUND OF THE INVENTION

Software development projects are increasingly including a “portability” requirement mandating that the software application function without modification in a variety of different platform environments (e.g. are “platform neutral” or “platform independent”). Some programming languages such as Java and C# can be considered “platform-neutral” programming languages because those languages were designed to foster platform-independence and thus are “platform neutral.” Java uses an interface known as the “Java virtual machine” between the software application and the underlying technical architecture and operating environment (collectively “platform”) in order to render the platform transparent to the software application. Platform neutral application code components (referred to as “bytecode” in Java applications) leave all platform-dependent processing, information, and cognizance for the virtual machine. The phrase “platform-independent” software applications is synonymous with “platform independent” software applications with the respect to the ability to distribute a software application across multiple platforms without modification of the software application.

“Platform neutral” software applications need not be limited to Java, C#, or some other programming language that is specifically designated to be “platform neutral.” While other types and categories of programming languages may not have been specifically designed to create “platform neutral” software applications, a wide variety of different programming languages can utilize the Java virtual machine, a different form or embodiment of a virtual machine (such as a non-Java virtual machine), or some other extra interface layer (collectively “virtual machine interface”) in order to support “platform-independence” in those particular programming languages. The use of a virtual machine interface can transform many different computer programming languages into “platform-independent” programming languages.

Regardless of the particular embodiment of the virtual machine, the flexibility of platform-independent software applications raises challenges with respect to ability to debug those software applications as they run, or in a retrospective analysis after application failure. A virtual machine typically incorporates computer code components written in a variety of different languages, which means that the software application using the virtual machine typically interacts with and utilizes computer code components that are written in one or more programming languages that are different from the programming language of the software application itself. In a virtual machine or platform-independent application architecture, the execution of a software application requires the use of an extra layer of computer code residing in the virtual machine. It is this extra layer of computer code, with the extra set of code component interactions that makes debugging difficult.

The debugging of software applications in their runtime environments is often a necessary step in the process of identifying subtle errors in complex software systems. It is not uncommon for a software application to utilize a wide variety of different code components. The virtual machine requires significant non-application-code components in order to function. For example, the virtual machine typically requires the use of code-components in native-code libraries. Native-code libraries are code components written in a different programming language than the programming language of the software application. Native-code components are compiled into platform-specific code and may be used by the virtual machine, and/or by the software application itself. The use of platform neutral software applications is further complicated by the increasing demand for distributed systems using object-oriented technology to compartmentalize complexity. Such systems require an increasing number of computer code components to interact with each other. When errors or “bugs” occur, it can be very difficult to isolate the source of the problem when so many different code components interact with each other in ways that are difficult to detect or foresee. Effective debugging tools are particularly important in situations involving software applications written in platform-independent (e.g. platform neutral) languages because the existence of an additional layer, such as a virtual machine, requires many interactions between the various components of the compartmentalized infrastructure.

Currently available debugging tools and techniques for platform-independent runtime environments are inadequate. The existing art does not provide a way to debug both the software application and the non-application code components used by the software application in a comprehensive and non-intrusive manner. The attributes of an interface such as a virtual machine that provides for platform transparency also interferes with the existing techniques and tools for the effective debugging of the runtime environment, which is platform dependent. Some existing art has attempted to use embedded agents and other forms of intrusive specialized application processing to enhance debugging capabilities, but such intrusive measures alter the runtime environment being debugged and are often limited, by virtue of their intrusiveness, in the amount of information that they can provide. Existing art techniques are limited to debugging either the software application or the non-application code components. Practitioners in the field sometimes attempt the use of concurrent but separate application and non-application code debugging tools to address this need. Sometimes, the application and non-application views are attempted to be merged into a single graphical user interface. However, such an approach is not acceptable because the process is unwieldy, does not provide an integrated view of the runtime environment, and cannot be used for a “post-mortem” or retrospective failure analysis.

Some prior art debuggers use what is called a virtual machine debugger interface. Such tools are quite limited in their scope since they cannot be used for post-mortem failure analysis, and do not provide an integrated view of both application code components and non-application-code components. Such tools also require an embedded agent, and an a priori declaration of intent to debug the application code component at the time of execution. Other recent debugging approaches use what is known as a non-invasive “serviceability agent” approach, but such approaches focus on the analysis of the internal workings of the virtual machine, and are not well suited for general purpose debugging. “Serviceability agent” approaches also rely on non-standard approaches for collecting debug information from native-code components, which hinders the usage of such approaches in the context of general purpose debugging.

It would be desirable for a debugging tool to provide debugging information relating to both the application-code component and the non-application-code component of a software application.

### SUMMARY OF THE INVENTION

The invention is a method or system for debugging a software application. The invention can be used to debug both the application-code component(s) and the non-application-code component(s) of the runtime environment of the software application. A debugging tool generates a debugging metric through inspection. The system can be configured to generate a wide variety of different types and categories of information in the debugging metrics. The debugging tool generates a non-application-code metric from the non-application-code component and an application-code metric from the application-code component. The debugging tool integrates the non-application-code metrics and application-code metrics to present a single, consistent debug view of the runtime environment.

### BRIEF DESCRIPTION OF THE DRAWINGS

Certain embodiments of present invention will now be described, by way of examples, with reference to the accompanying drawings, in which:

FIG. 1 is a high-level flow diagram illustrating one example of a distributed processing architecture, with separate application, database, and proprietary code base servers.

FIG. 2 is a block-diagram of a platform-independent architecture utilizing a virtual machine as an interface between a software application and an operating system.

FIG. 3 is a data listing illustrating one example of the debugging metrics generated by a prior art debugger.

FIG. 4 is a data listing illustrating an additional example of the debugging metrics generated by a prior art debugger.

FIG. 5 is a block diagram illustrating one example of a Java unwind library being interfaced with a debugging tool in order to generate debugging metrics.

FIG. 6 is a structural diagram illustrating one example of a compiled frame layout.

FIG. 7 is a structural diagram illustrating one example of an interpreted frame layout.

FIG. 8 is a process-flow diagram illustrating one example of how a method map can be used by a debugging tool.

### DESCRIPTION OF THE PREFERRED EMBODIMENTS

### I. Introduction and Definitions

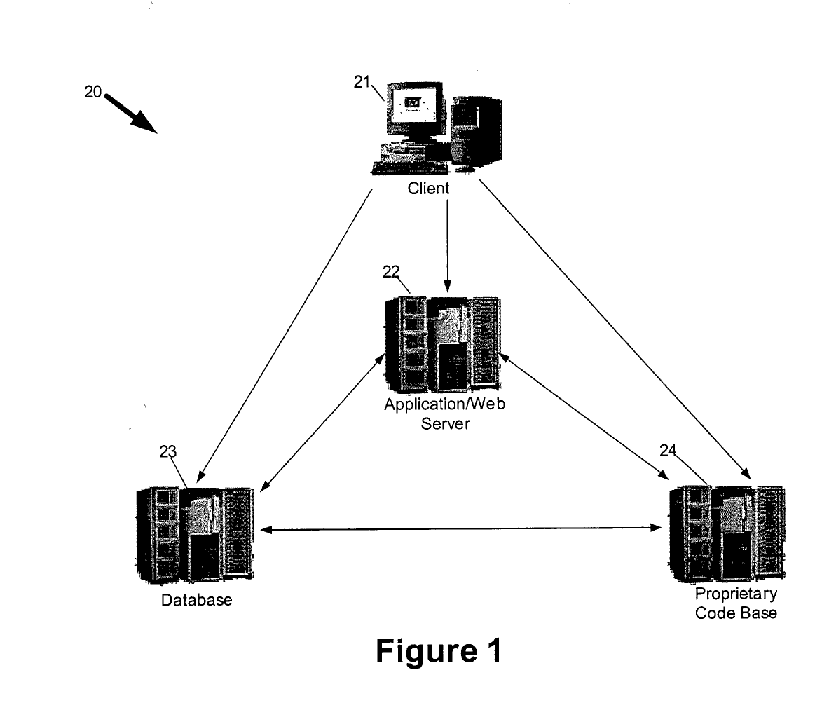

The present invention is a method and system for comprehensively and non-intrusively debugging a software application and non-application-code components invoked by the software application. FIG. 1 illustrates one of many potential embodiments of a debugging system 20 (or simply “the system”) in a distributed processing environment. The debugging system 20 can be incorporated in a wide variety of different embodiments, and can include a wide variety of different interfaces, software applications, operating systems, programming languages, object libraries, function libraries, computer hardware, architecture configurations, processing environments, operating systems, and other environmental characteristics. The present invention can be applied to potentially any component in FIG. 1.

A. Different Types of Computer Code Components

The runtime environment of a software application includes two primary types of software or computer code components (“code components”).

1. Application-Code Component

The first type of code component that can be profiled by the system 20 is the software application (“application-code” component). In many embodiments of the system 20, the application code will be an application or applet (collectively “application code”) written in the platform-independent programming language of JAVA®. JAVA is a registered trademark of Sun Microsystems, Inc., located in Mountain View, Calif. A “platform-independent” software application means that the application code is “platform neutral” (e.g. that it can be distributed and run across different technical platforms). “Platform-independent” is synonymous “platform neutral” with respect to the types of software applications that can be profiled by the system 20. An example of platform neutral application-code is “bytecode” in the Java programming language. Alternative embodiments of the system 20 may utilize other platform-independent programming languages, and/or platform-independent techniques (such as virtual machines or other interfaces) not related to the programming language of Java or similar languages such as C#. As discussed above, virtual machines and other forms of interfaces (collectively “virtual machine interfaces”) between a software application and the underlying technical architecture and operating environment (collectively “platform”) can render the software application “neutral” to any particular platform. Virtual machine interfaces can transform a computer programming language not known for high portability and platform neutrality, into a “platform-independent programming language.” Other alternative embodiments of the system 20 do not require the use of a virtual machine interface.

Platform-independent programming languages and techniques typically facilitate platform neutrality and portability by positioning an interface layer between the software application and the underlying technical platform, rendering the underlying technical platform transparent to the software application. The software application can thus interact with the highly abstract and generic virtual machine interface, instead of a particular platform with platform specific characteristics. Thus, it is not uncommon for a virtual machine interface to incorporate code components written in a variety of different languages. This means that the software application using the virtual machine interface typically interacts with and utilizes computer code components that are written in one or more programming languages that are different from the programming language of the software application itself. In a virtual machine interface, the executing of a software application utilizing the virtual machine necessarily invokes computer code components within the virtual machine that enable virtual machine to function as a virtual machine.

One common example of a virtual machine is the “Java virtual machine” (“JVM”) that is typically used in conjunction with software applications and applets (collectively “applications”) written in Java. However, the Java virtual machine can be configured to operate for other programming languages and graphical user interface (“GUI”) tools, rendering those languages and tools potentially “platform independent” (e.g. “platform neutral”). Similarly, other virtual machines designed with a particular application language in mind can be configured to allow utilization by application code components of a different type. For example, a C++ virtual machine could render C++ “platform independent.”

There are nearly a limitless number of combinations and environments that can utilize one or more different embodiments of the debugging system 20. However, platform independent architectures and interfaces tend to present greater debugging challenges than other architectures and platforms due to the different language combinations, the nature of virtual machines, and the greater number of code components that typically need to interact with each other when platform-independent techniques are used. Despite the difficulties associated with such environments, the system 20 can comprehensively debug platform-independent runtime environments as well as environments based on more traditional structures and languages, in a non-intrusive manner. The system 20 does not need to utilize embedded agents in the application-code component to obtain debugging information in the form of “debugging metrics.” Moreover, use of the debugging system 20 does not require any special preparation of the software application. The debugging system 20 can be invoked either before or after the software application to be debugged is executed. Use of the debugging system 20 does not require any cognizance of the debugging system 20 or a known or expressed intention by a human user or automated system utility to debug the software application, at the time in which the software application is executed. The system 20 is extremely flexible with respect to allowing a user to invoke the system 20 at a moments notice.

2. Non-Application-Code Components

The second type of code component includes all types of code components not included in the application code. The second type of code component can be referred to as “support code,” “environmental code,” or simply “non-application-code” components. Non-application-code includes any code component that is needed by the application code in order to function properly, but does not reside within the application code itself. Categories of non-application-code can include libraries of reusable functions (written in programming languages that are either identical, similar, or different than the software application), libraries of reusable objects, databases, network communication tools, code used for the functioning of the virtual machine, and assembly language communications to the underlying hardware on the system 20. Code components relating to the virtual machine can be referred to as “virtual machine code components” or “virtual machine code.” Code components written in a programming language different than the language of the software application and not executed by the virtual machine can be referred to as “native code components” or “native code.” In a typical Java environment, the term “virtual machine code” is a subset of “native code” because all of the virtual machine code components are written in a language that is different than the language of the Java application. Virtual machine code components are typically written in a non-Java language such as C or C++, but may be written in a wide variety of different programming languages. Use of the debugging system 20 does not require the embedding of“agents” into the non-application-code component being debugged.

B. Debugging Metrics

The debugging system 20 analyzes the runtime environment of the application-code-component and the non-application-code component(s) used by that software application to support the running of the application-code component. A debugging metric is a characteristic or attribute relating to the runtime environment of the software application. Many embodiments of the system 20 can generate multiple debugging metrics relating to the runtime environment. There are a wide variety of different debugging metrics that can be tracked and reported by the system 20. Some debugging metrics relate to the global use of an application (“global debugging metrics”). For example, one debugging metric may be the value of a global variable, i.e. a variable accessed by many different application-code components and non-application-code-components. The objects that are subject to being measured in these metrics typically have two representations, one corresponding to the application code language and another corresponding to the implementation language. The debugging system 20 can present both representations of such objects. Many debugging metrics (“local debugging metrics”) relate to a particular function, routine, method, class, object, data object, process, data structure, file, or variable (collectively “routine” or “frame”). Frames represent the smallest unit, process, or routine that the debugging system 20 can identify as a distinct unit, process, or routine. Frames can also be referred to as activation records. One example of a local debugging metric is the memory address of a particular data structure. Other examples could include the particular routine that was invoked by a preceding routine, a change in a local variable by a particular routine, etc. Alternative embodiments can include other forms of local debugging information.

In addition to classifying debugging metrics as global or local, debugging metrics can also be referred to in relation to the particular structural component. For example, a kernel metric is a category of one or more debugging metrics generated by the debugging system 20 that relate to the kernel. Similarly, a native-code metric is a category of one or more debugging metrics generated by the debugging system 20 from the native-code components in a native-code library. An application metric is a category of one or more debugging metrics generated by the debugging system 20 from the application-code components in the software application. The application metric can include both class information and method information, in addition to information relating to data structures and particular variables. An operating system metric is a category of one or more debugging metrics generated by the debugging system 20 that relate to the operating system. In many situations, operating system metric is synonymous with kernel metric. A virtual machine metric is a category of one or more debugging metrics generated by the debugging system 20 that relate to the virtual machine. Thus, in many circumstances, virtual machine metric is synonymous with native-code metric, because the virtual machine is primarily or entirely composed of native-code components.

Debugging metrics can also provide information relating to the compilation of various components, especially when those components are compiled at runtime. A compilation metric is a category of one or more debugging metrics generated by the debugging system 20 that relate to the compiling of a code component used by the software application. The compilation metric can include a compiler log that tracks the order of compilation or de-compilation. The system 20 can also associate the ability to issue notification when certain compiler related events occur. With certain programming languages, of which Java is one example, methods and routines can be compiled and re-compiled in a dynamic manner at runtime. Different embodiments of the system 20 can focus different levels of attentiveness on different categories of debugging metrics.

C. Hardware Configuration

Returning to FIG. 1, the debugging system 20 can be invoked by a client 21. The invocation of the debugging system 20 can be through a user accessing the client 21 through a user interface. The debugging system 20 can also be automatically invoked by a particular event (such as a failure or error) or an elapsed period of time. Thus, the debugging system 20 can be configured to activate periodically in an automated fashion by the client 21 or some other computer, without any human intervention.

The client 21 can be any type of device capable of communicating with another device, including but not limited to a desktop computer, laptop computer, work station, mainframe, mini-computer, terminal, personal digital assistant, satellite pager, or cell phone. The software application can be executed from a different client 21 than then client used to invoke the debugging system 20.

An application/web server 22 may house the software application to be debugged by the debugging system 20 or the software application may be found in a “stand-alone” non-networked computer. As described above, the software application may require the use of a native-code library at runtime. The native-code library can reside in: the application/web server 22; a proprietary code base server 24; partially in the application/web server 22 and partially in the proprietary code base server 24; or in some other server or combinations of servers. Any device capable of running a software application and communicating with other devices can serve as an application/web server 22. In many embodiments, the application/web server 22 will possess greater computing power than a client 21 because the application/web server 22 will often need to support numerous clients 21. The client 21 can communicate with the application/web server 22 in a wide variety of different ways. The client 21 and application/web server 22 can be connected by a Local Area Network (“LAN”), a Wide Area Network (“WAN”), the Internet, an extranet, an intranet, a wireless network, or any other form of device-to-device communication. In many embodiments of the system 20, the user interface invoking the debugging system, the debugging system 20, and the software application will each reside in different devices and thus are remote from each other. It may be the case that each of various locations is protected and separated by a firewall. The system 20 can still be launched and fully utilized in such an environment, despite the remote location and the existence of one or more firewalls. Moreover, the debugging system 20 does not interfere or modify the flow of control in the software application in generating debugging metrics. The system 20 can be configured so that only an explicit request by the system 20 will result in a modification in the flow of control in the software application.

The debugging system 20 can be used to debug software systems that include additional components such as a database 23 and/or a proprietary code base 24. The database 23 can be located on a separate server reserved exclusively for the database. The configuration of the database 23 is largely dependent on the software applications using the database. The database can reside in a wide range of different types of devices, just as the client 21 and application/web server 22 described above. In some instances, the database itself may be the target debugging application if it includes both application code and non-application code components.

The proprietary code base 23 can contain libraries of reusable functions, libraries of reusable objects, the code components making up the virtual machine, native-code components, and virtually any other code component that is not application code. The proprietary code base can reside in a wide range of different types of devices, just as the client 21, application/web server 22, and database 23, as described above. In some instances, the proprietary code base itself may be the target debugging application if it includes both application code and non-application code components.

In most embodiments, the various hardware components in FIG. 1 can all communicate directly with each other. Different embodiments can utilize different degrees of distributed processing techniques and structures.

### II. Structure of Code Components

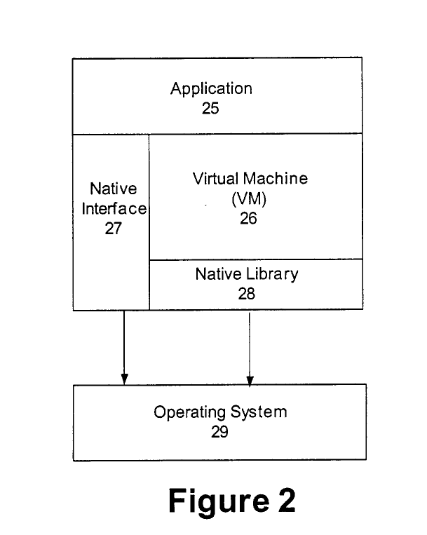

As discussed above, application-code components and non-application-code components can be incorporated into the system 20 in a wide variety of different ways. Many embodiments will utilize a virtual machine. FIG. 2 illustrates one example of such a virtual machine.

At the top of the diagram is the software application 25. The software application 25 includes the executable application code component, and any other application-code components that can be utilized by the software application. In a Java embodiment of the system 20, the application code 25 is written in Java, and the application is either a Java applet or application (collectively “application”).

Underneath the software application is a native interface 27 and a virtual machine 26. In a Java embodiment of the system 20, the native interface 27 is a Java native interface (“JNI”) and the virtual machine 26 is a Java virtual machine (“JVM”). Java Native Interface 27 is a standard programming interface for writing Java native methods and embedding the Java virtual machine 26 into native (non-Java) software applications. The primary goal of a typical JNI 27 is source compatibility of native method libraries across all Java virtual machine implementations on a given platform. The Java virtual machine (JVM) 26 is a virtual computer, typically implemented as software on top of an actual hardware platform and operating system. The JVM 26 typically runs Java programs that have been compiled from Java source code to a platform neutral format executable on a Java virtual machine. The Java virtual machine facilitates portability and platform independence, as discussed above. In non-Java embodiments, the native interface 27 and virtual machine 26 perform essentially the same functions as they do in the Java embodiments, although more customization may be required in such embodiments. Moreover, even non-Java embodiments can use a Java virtual machine 26. In a non-Java embodiment, native-code components are supporting code components that are written in a programming language that is different from the programming language used to write the software application 25 and other application-code components.

Beneath the virtual machine 26 is a native library 28. In many embodiments, the virtual machine 26 will include non-application-code components written in a different language than the software application 25. The code components used to run the virtual machine can require the use of reusable functions and other code components. Such code components can be stored as native-code components in the native library 28.

Underneath the native interface 27 and the native library 28 is an operating system 29, which includes a kernel for core operating system functions such as launching (executing) software applications, allocating system resources, managing memory, managing files, and managing periphery devices. The system 20 can incorporate a wide variety of different operating systems such as Unix, Linux, Windows, and other commercially available and/or proprietary operating systems.

As is illustrated in the Figure, modern software architectures involve many different components and layers that need to interact with each other. The system 20 provides a way to debug such systems in an integrated manner, debugging both application-code components and non-application code components. No embedded agents are required in order for the system 20 to effectively debug complex software infrastructures. The system 20 can generate a compiler annotation as a debugging metric, assisting in the contextual analysis of the software application at runtime. The system 20 can store such compiler annotations in a small memory footprint that is accessible from outside the system 20 as well as from within the system 20. Despite the complexities illustrated in the Figure, the system 20 can correctly categorize the executing code (both application-code components and non-application-code components) and enable forward and backward traversal across multiple calling conventions through a contextual analysis conducted at runtime. Despite the highly compartmentalized structure illustrated in the Figure, the system 20 does not modify a flow of control in the software application at runtime. The system 20 can be invoked for a “live” software application analysis while the software is still running, or for a “post-mortem” failure analysis of a crashed application.

### III. Debugging Metrics

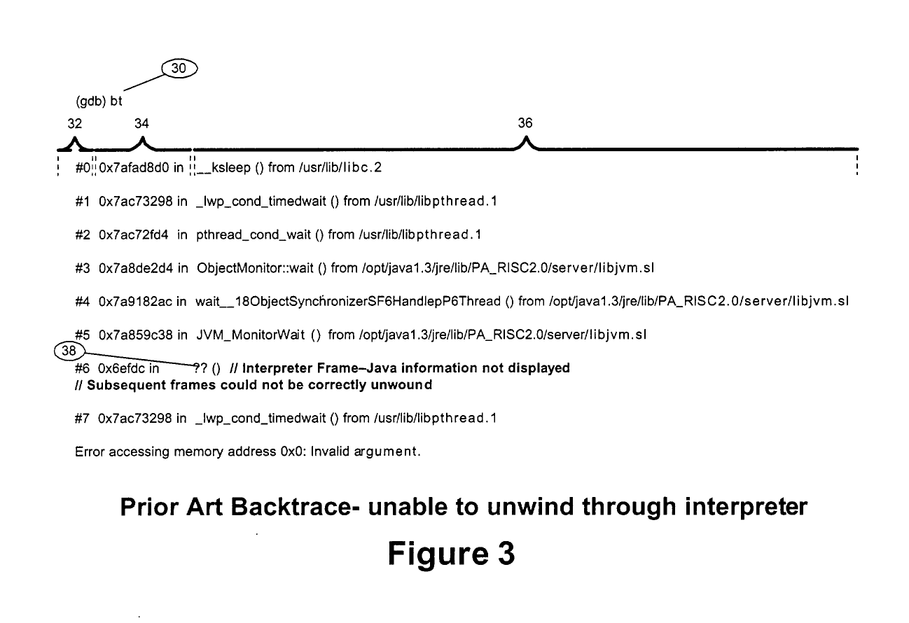

FIG. 3 is an example of a debugging metric listing in a prior art debugging tool. The debugging metrics illustrated in the FIG. 2 exemplify one of the weaknesses in prior art debugging tools, the inability to comprehensively debug both the software application and the non-application-code components that are necessary for the functioning of the software application. The particular example illustrated in FIG. 2 relates to a software application written in the Java programming language where the top frame is stopped in an operating system library, called from the Virtual Machine 26, which was called from the application code. The debugger used in the illustration is a GNU debugger (“gdb”), a product of the Copyright Free Software Foundation. In some embodiments of the system 20, the system 20 interfaces with and incorporates a prior art debugging tool such as the gdb. In other embodiments of the system 20, the functionality of prior art debugging tools is re-created within the system 20 itself.

At the top of the debug listing is a text reference to “(gdb) bt” 30. As discussed above, “gdb” refers to a particular prior art debugger. The letters “bt” refers to a backtrace. A “backtrace” is a phrase that can be used to describe some debugging metrics. A “backtrace” is a step-by-step breakdown of routines that illustrates the order of invocation of these routines, and allows human beings to observe the functioning of the software application 25 on a step-by-step basis.

The backtrace results are displayed in three columns in FIG. 3. A first column assigns a sequential number 32 to the particular routine identified by the backtrace. The second column discloses a memory address 34 of the particular routine. The third column is a description of the event or routine that has occurred.

Looking further down the Figure at 38 is an example of how prior art cannot perform integrated debugging. Prior art gdb does not support the non-intrusive stack unwinding of Java programs (application-code components) and many of the non-application-code components used to support such Java software applications. Prior art gdb also does not support the post-mortem analysis of crashed Java programs which are sometimes referred to as “core files.” At 38, no information regarding the particular event or routine is provided because the prior art backtrace could not unwind through an interpreter frame. In some embodiments, an interpreter is included in the runtime environment of the virtual machine. An interpreter is a non-application-code component that translates and then executes each statement in the application-code-component. In some embodiments, interpreters are generated statically. In other embodiments, interpreters are generated at runtime. Prior art debugging tools do not have access to interpreter unwind information, and they also may not have a cognizance of the stack frame layout used by the interpreter. This leads to the inability to unwind through an interpreter frame. Interpreter frames can play an important role in virtual machine interfaces. The inability to unwind through an interpreter frame means that the neither the application nor the virtual machine can be debugged. Stack unwinding is important for debugging virtual machine problems and problems relating to core files, which can include both application-code-components and non-application-code components. Moreover, subsequent frames could not be correctly unwound, and so the backtrace in FIG. 3 ultimately did little to identify the source of the problem. Interpreter frames and compiled frames can utilize a wide variety of different calling conventions. The calling convention for a frame can have a significant impact on the ability to correctly generate debugging metrics for the frame.

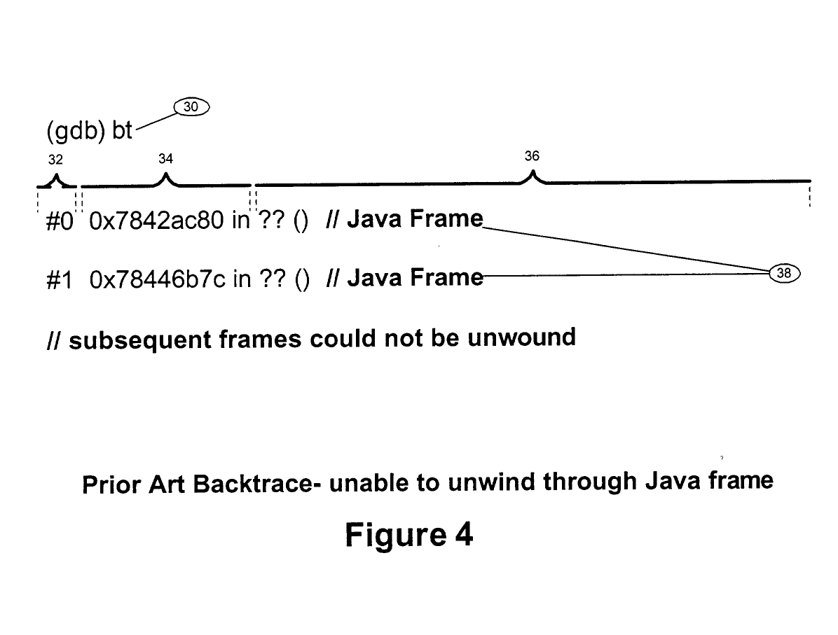

FIG. 4 is an example of a prior art backtrace being unable to debug the software application itself due to an inability to unwind through a Java compiled method frame of an application-code-component. Similar to FIG. 3, “(gdb) bt” 30 is displayed at the top of the Figure, illustrating the tool used to generate the backtrace. The first column at 32 assigns a sequential number to each frame as the software application runs. The second column at 34 is a memory address of the particular frame. The third column at 36 is the description of the processing in that particular frame. The question marks displayed at 38 illustrate that the prior art backtrace was not unable to unwind through the Java application frame.

### IV. Debugging Tool

There are many obstacles in creating a debugging tool that can debug application-code components, virtual machine components, and other native-code components.

Many languages support the use of multiple threads in an application. A thread is simply a unit of execution that can be scheduled independently. Each thread has a stack that represents the sequence of the invocation of routines by this thread. Each routine invocation has an associated frame. The frame corresponding to a routine depends on whether or not the routine is an application-code-component that is executed by the interpreter, whether or not the routine is an application-code-component that is compiled at run-time, or whether or not the routine is a non-application-code-component. Many virtual machines fill the application thread stacks with frames of mixed-language and mixed calling conventions. As discussed above, mixed-language frames, where the languages used are C/C++ and Java, cannot be unwound by existing debuggers. Moreover, different languages generate frame information differently. For example, Java frame information is available only at runtime, while C and C++ frames information is generated at compile time and is available at any subsequent time. Adding to the difficulty discussed above, some application-code-component frames do not conform to conventional platform specific run-time or calling convention standards, making it difficult for debuggers to debug software applications with mixed-language frames.

The system 20 can overcome such obstacles. The system 20 can interface with the virtual machine for generating debugging information at runtime. In some embodiments, the debugging information is captured in an “unwind table” (e.g. a “method map”). The unwind table can be interfaced with a prior art debugger such as gdb. In other embodiments, the system 20 will incorporate such functionality directly without interfacing or incorporating any other products.

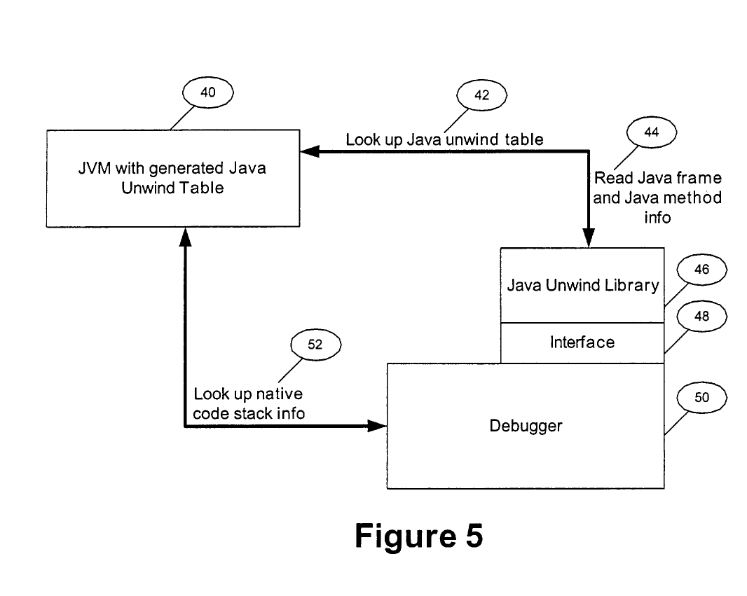

FIG. 5 is an example of one Java embodiment of the debugging system 20. As discussed below, the diagram is also applicable for other non-Java unwind table embodiments.

The virtual machine 26 generates an unwind table at 40. The virtual machine 26 is described in greater detail above. The unwind table is described in greater detail below. The unwind table can be dynamically generated for application compiled methods, adaptors, and runtime stubs. The unwind table can collect additional virtual machine data for a subsequent stack unwind. If the interpreter is also generated at run-time, additional information about the run-time interpreter can be collected. Other additional information can include information about the range of addresses for the dynamically compiled code, a number of entries containing information in the unwind table (e.g. “method map”), and a wide variety of other potential data.

If the current frame being debugged is a native-code frame, the native-code stack information is looked up at 52 and processed by a debugger 50. The debugger 50 can be a prior art debugger (such as gdb) that is interfaced with the system 20, or the debugger 50 can be created from “scratch” with the appropriate corresponding functionality.

If the current frame being debugged is an application-code component, a lookup of the unwind table is performed at 42 and the frame and method information can be read into an unwind library 46. Before the frame and method information is sent through an interface 48 to the debugger 50, the unwind library generates the specific formatted text that is to be included in the debugging metric for the software application 25 by the debugger 50. The processing between the unwind table and the unwind library is described in greater detail below.

The unwind shared library can be loaded by a debugger process for many debuggers, such as gdb. This can leverage the existing features of existing debugging tools. Virtual machine or core file memory can be read directly into an internal representation of the unwind table within the unwind library. Application frame information can be extracted in the other direction. The unwind library can provide application symbol information to the debugger so that appropriate text messages and information can be inserted into the debugging metrics generated by the system 20. The unwind shared library can encapsulate the frame structure and virtual machine data for the debugger.

The interface 48 between the debugger and the unwind library can utilize various functions. A function such as a get_frame_str( ) function can be used to return a string describing the application-code frame for the debugger to print out in a backtrace command. Another function, such as a get_prev_frame_intro( ) function, can be used if the current frame is an application frame, and its previous frame information can be returned.

### V. Frames

As discussed above, the system 20 can debug mixed-language frames in thread stacks. In a Java embodiment, there can be a variety of adapter frames that manage invocation from one language to another, or from one calling convention to another, or other special purpose transitions. A Java embodiment can also include interpreted frames by which the platform-independent version of the application code component is executed, and compiled frames by which the dynamically compiled platform dependent version of the application code component is executed. Frames can have many different attributes or characteristics. One attribute of a frame is frame type.

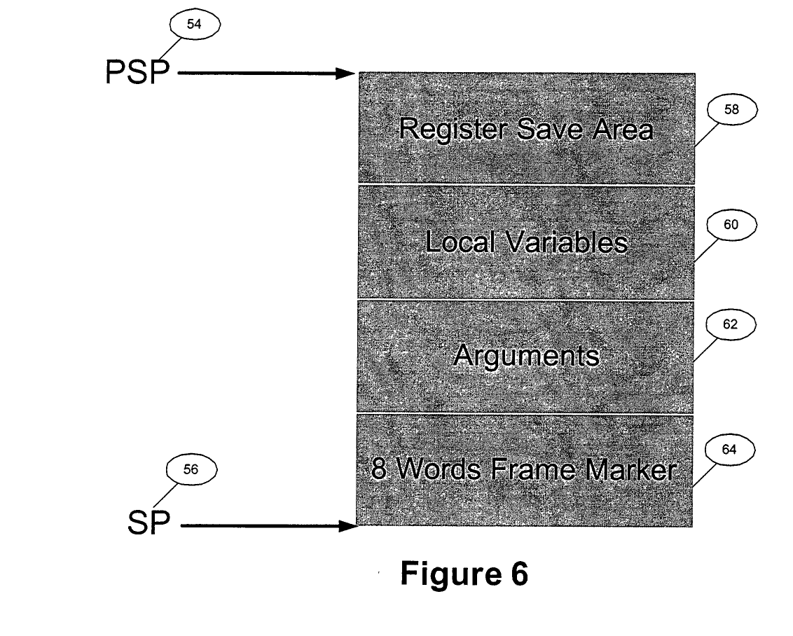

FIG. 6 is an illustration of a compiled (application) frame. A register save area 58 is an area in the stack frame set aside for preserving register values specific to a runtime or calling convention. A local variable at 60 is a variable of the frame, but not the global software application 25. An argument 62 is a passed variable for the frame, which can either be a global variable, or a local variable originating from another frame. A frame marker 64 is an area in the stack frame set aside for preserving runtime or calling convention specific data such as the procedure return address, exception handling information, and other types of data and information.

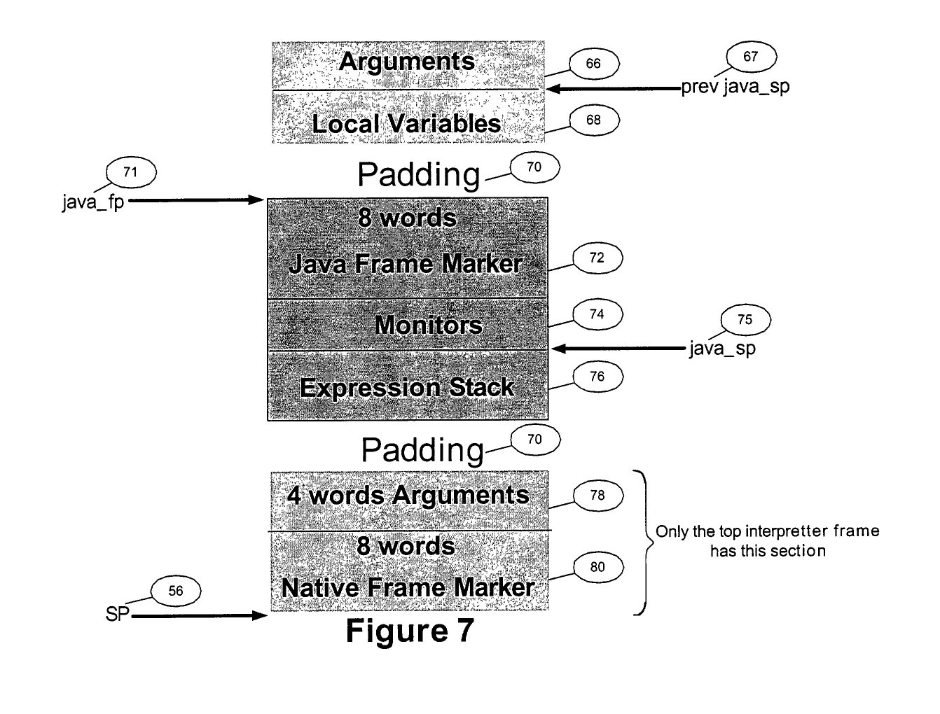

FIG. 7 is an illustration of an interpreter frame incorporated by the system 20. The interpreter frame in FIG. 7 is not identical to the program analysis native-code frames as the compiled frame of FIG. 6.

At the top of the interpreter frame are the arguments 66 and local variables 68. Arguments 66 are inputs passed by a previous application frame (prev java_sp or “previous java stack pointer ” 67). Similarly, the local variables 68 also originate with the invocation of a frame by the previous frame.

A frame pointer (fp) 71 relating to a current frame 75 (java_fp) is separated from the previous frame 67 by a layer of padding 70. Padding 70 can be used to separate the various layers of the interpreter frame. Padding 70 is the addition of one or more bytes to a block of data in order to fill it, to force the alignment of actual data bits into a particular position. An eight word frame marker 72 is an area for holding metadata about the particular frame, that identifies the structure of the interpreter frame. One or more monitors 74 can enforce mutual exclusion for all threads.

An expression stack 76 is a stack (an object class that stores data in Last In First Out manner) that holds the operands for the execution of the application language

Below the expression stack 76 is padding to separate the existing application interpreter stack frame from the frames of potential future native code execution due to runtime/calling convention specific requirements. Only the top interpreter frame has the 4 word arguments 78 and 8 words native frame marker 80. The marker 80 includes information identifying the size and nature of the interpreter frame. The arguments 78 are the inputs to the next interpreter frame or activation record.

### VI. The Unwind Table (e.g. “Method Map”)

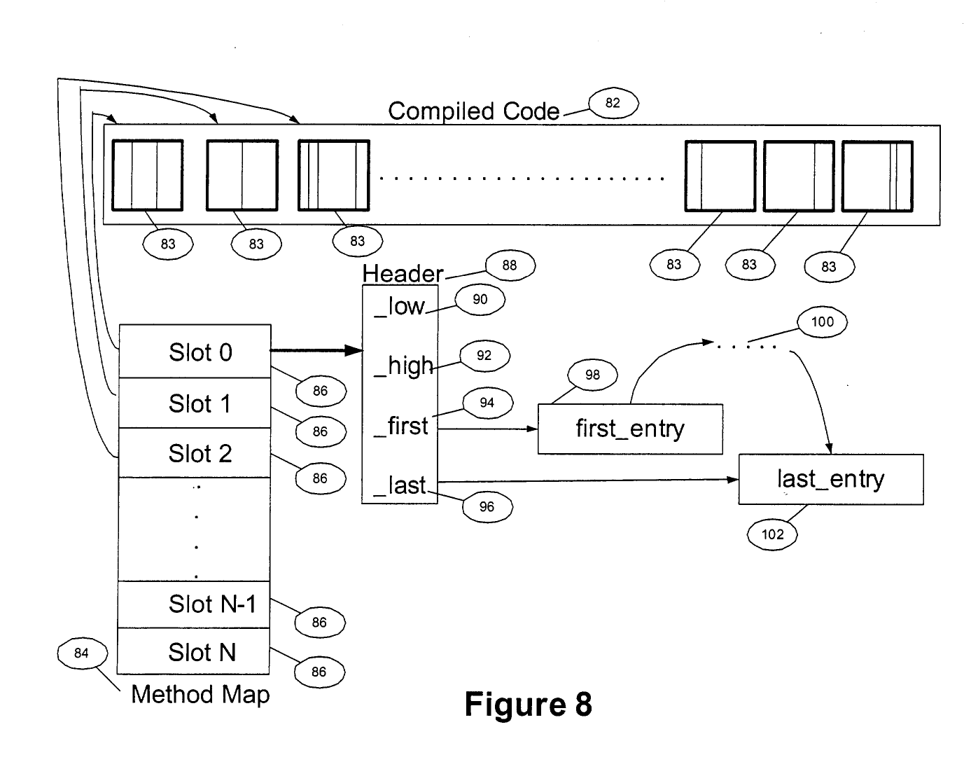

The unwind table is used by the system 20 to correlate the debugging metrics at the individual frame and method level. The unwind table can also be referred to as a “method map” 84 because it is used by the system 20 to correlate the debugging metrics at the individual routine or “instruction” level. FIG. 8 is an illustration of the how the method map 84 can be used by the system 20. The execution of a particular instruction, method, thread, routine, or process (collectively “instruction”) is recorded in a data structure by the debugging system 20, so that debugging metrics can be generated that include application metrics relating to the various instructions.

In a Java runtime embodiment, a runtime compiler creates platform specific versions of instructions (e.g. compiled code 82) that are executed by the application and retained as a method map 84 in memory. The runtime compiler can be instructed to generate platform specific versions of all instructions, or can be limited to generate platform specific versions of only a few selected instructions. A method map 84 can be instantiated to act as a repository of information about instructions that currently have platform specific versions. The method map 84 can capture such information on an instruction-by-instruction basis as the runtime compiler processes these instructions to generate platform specific versions. In non-Java embodiments, other objects, data structures, and/or files can be used to fulfill the same functionality. The memory used to hold the platform specific versions of the routines can be logically partitioned into various subspaces 83, with each subspace 83 holding a finite collection of instructions. The size of such subspaces can be arrived through consideration of the various tradeoffs, and alternative embodiments may utilize subspaces that vary widely in storage capacities.

The method map 84 can have a hash table data structure to minimize the time and resources consumed for adding entries, deleting entries, and searching entries on the method map 84. The method map 70 can have virtually as many slots 86 as are needed, up to N slots, where N can represent the number of application code entry points or methods invoked in the runtime environment during the profiling of the software application 52. Each slot 86 on the method map should preferably correspond to a memory subspace 83. The component debugging metric correlators are loaded into the method map 84. The first_instruction of each entry is the hash table key. Each slot can hold the method map entries whose first_instruction is in the corresponding memory subspace 83. Each slot chain can be ordered by the first_instruction for the particular entry. The types of links data formats used by the method map 84 can vary widely in a wide variety of different embodiments.

A header table 88 can be used to further optimize the process of adding and deleting content from the method map 84. In the header table, _low 90 is the instruction_start for a first_entry 98 in the slot, _high 92 is the instruction_start for a last_entry 102 in the slot, _first 94 designates a first_entry 98, and _last 96 designates a last_entry 102. The first_entry 98 though last_entry 102 (including all entries 100 in between the first_entry 98 and the last_entry 102) in the slot can further contain method map entries (MethodMapEntries) such as the example displayed in Table A. In non-Java embodiments, the equivalent entry can be created.

TABLE A

MethodMapEntries

| | |
|---|---|
| [0067] EntryType | [0068] _type |
| [0069] MethodMapEntry | [0070] *_next |
| [0071] Address | [0072] First_instruction |
| [0073] Address | [0074] Last_instruction |
| [0075] Int | [0076] frame_size |
| [0077] MethodInfo | [0078] *_methodDescdptor |

Debugging metrics can be generated as a part of the process of adding or deleting entries from the method map 84. The debugging metrics can act as a correlator or “meta data” that helps the debugger in the system 20 generate application code metrics from samples observed by the debugger. If debugging metric collection is activated dynamically through the use of the signal mechanism, all the entries generated from the beginning of the application run are communicated to the profiler by traversing the method map table.

### VII. Non-Java and other Alternative Embodiments

Many of the code examples and illustrations used above relate in some way to the Java programming language. However, use of the system 20 is not limited to Java, platform-independent programming languages, or even object-oriented programming languages. The use and functionality of a method map 84 can be supported for a wide variety of different categories of programming languages. Other programming languages can support the implementation of data structures, objects, database tables, and other techniques that can achieve the functionality of the method map 84 described above. Similarly, the functionality of the various frames can also be supported by a wide variety of different programming languages and platforms. Additional information that aids in debugging can also be provided in the system as debugging metrics. For example, including but not limited to, data structures can be generated that contain the addresses of local variables, or a register number when the current value of the local variable is in a register, for a specific range of PC values. The additional information can be included in the method map 84 and referenced from the method map 84, or it can exist elsewhere but be accessible during debugging.

Differences between the programming language of the software application 52 and the underlying native code library may make use the system 20 especially advantageous in the debugging of runtime environments that utilize virtual machine interfaces, but even virtual machine 62 embodiments are not limited to the Java programming language. Virtual machines 62 can be used to facilitate platform-independence in non-Java languages. For example, a virtual machine could be created to support programming languages including but not limited to C++, Curl, COBOL, C, BASIC, JavaScript, Visual Basic, FORTRAN, and others. Moreover, a Java virtual machine 62 could be modified to facilitate use by non-Java languages. The system 20 described above is not limited to any particular technology, programming language, or other environmental limitation and should be viewed as expansively as possible. For example, programming languages and architectures developed in the future may be superior to Java and other currently existing languages. The system 20 can be utilized in such future environments, as well as other currently existing embodiments.

It should be understood that various alternatives to the embodiments of the invention described herein may be employed in practicing the invention. It is intended that the following claims define the scope of the invention and that the method and apparatus within the scope of these claims and their equivalents be covered thereby. It is anticipated and intended that future developments will occur in programming languages and information technology systems, and that the invention will be incorporated into such future embodiments.

What is claimed is:

1. A debugging system for a software application, comprising:
a software application written in a platform-independent programming language;
a non-application-code component invoked by said software application; and
a debugging tool for generating a debugging metric, said debugging metric including an application metric and a non-application-code metric, said debugging tool generating said application metric from said software application and said debugging tool generating said non-application-code metric from said non-application-code component.

2. The system of claim 1, wherein said platform-independent programming language is Java.

3. The system of claim 1, wherein said non-application-code component is written in a different programming language than said software application.

4. The system of claim 1, said non-application-code component including a virtual machine component and said debugging metric further including a virtual machine metric, said debugging tool generating said virtual machine metric from said virtual machine.

5. The system of claim 1, said debugging metric includes a frame attribute.

6. The system of claim 5, wherein said frame attribute is a frame type.

7. The system of claim 1, further comprising a compiled frame calling convention, said debugging tool generating said debugging metric with said compiled frame calling convention.

8. The system of claim 1, further comprising an interpreter frame calling convention, said debugging tool generating said debugging metric with said interpreter frame calling convention.

9. The system of claim 1, further comprising an unwind table, said debugging tool generating said debugging metric with said unwind table.

10. The system of claim 1, further comprising an unwind table, an interpreter frame calling convention, and a compiled frame calling convention, said debugging tool generating said debugging metric with said unwind table, said compiled frame calling convention, and said interpreter frame calling convention.

11. The system of claim 10, further comprising an unwind-table pointer and an unwind-data pointer, said debugging system accessing said unwind table with said unwind-table pointer and said unwind-data pointer.

12. The system of claim 1, said software application not including an embedded agent.

13. The system of claim 1, said debugging metric including a virtual machine compiler annotation.

14. The system of claim 13, wherein said virtual machine compiler annotation is accessible from outside said debugging system.

15. The system of claim 1, further comprising a plurality of calling conventions, said debugging system generating said debugging metric across said plurality of calling conventions.

16. The system of claim 1, wherein said software application has already crashed.

17. The system of claim 1, said software application including a flow of control, wherein said debugging tool does not modify said flow of control without an explicit request.

18. The system of claim 1, further comprising a user interface and a firewall, wherein said debugging tool is launched remotely by said user interface across said firewall.

19. The system of claim 1, further comprising a user interface, wherein said software application is executed by said user interface before said debugging tool is executed by said user interface, and wherein said user interface is not cognizant of said debugging tool at the time that said software application is executed.

20. A debugging system for a software application written in the Java programming language, comprising:
a software application, including an application-code component and a flow of control, said application-code component comprising a plurality of calling conventions, wherein said debugging system does not modify said flow of control without an explicit request, and wherein said software application does not include an embedded agent;
a virtual machine interface, said interface including a virtual machine component, said application-code component executing on said virtual machine component;
a native-code library, including a native-code component, wherein said native-code component is written in a different programming language than said application-code component, and wherein said native-code component is said virtual machine component;
a debugging tool;
a debugging metric, including:
an application metric, said application metric generated with said debugging tool from said application-code component across said plurality of calling conventions;
a virtual machine metric, said virtual machine metric generated with said debugging tool from said virtual machine component;
a native-code metric, said native-code metric generated with said debugging tool from said native-code component; and
a runtime-compilation annotation, said debugging tool generating said runtime-compilation annotation at a runtime of said software application, wherein said annotation is accessible from outside said system.

21. A method for debugging the runtime environment of a software application, comprising:
executing a software application in a runtime environment that includes a non-application-code component;
invoking a debugging tool for debugging the runtime environment of the software application;
generating an application metric from the software application with the debugging tool; and
creating a non-application-code metric from the non-application-code component with the debugging tool.

22. The method of claim 21, wherein the invoked debugging tool does not use an embedded agent.

23. The method of claim 21, wherein creating the non-application code metric includes recording a virtual machine compiler annotation at the time the software application is executed.

24. The method of claim 23, further comprising storing the virtual machine compiler annotation in a repository, and identifying the virtual machine compiled code with a compiler annotation.

25. The method of claim 21, wherein executing a software application includes traversing across multiple calling conventions.

26. The method of claim 21, wherein invoking the debugger tool does not modify a flow of control in the software application without an explicit request.

27. The method of claim 21, wherein the debugging tool is launched from a client computer at a remote location.

28. The method of claim 27, wherein a firewall exists between the debugging tool and the software application.
